(19) United States
(12) Patent Application Publication
(10) Pub. No.: US 2013/0160793 A1
(43) Pub. Date: Jun. 27, 2013

(54) PLASMA GENERATING APPARATUS AND PROCESS FOR SIMULTANEOUS EXPOSURE OF A WORKPIECE TO ELECTROMAGNETIC RADIATION AND PLASMA

(71) Applicants: Aseem K. Srivastava, Andover, MA (US); Ivan Berry, Amsbury, MA (US)

(72) Inventors: Aseem K. Srivastava, Andover, MA (US); Ivan Berry, Amsbury, MA (US)

(73) Assignee: AXCELIS TECHNOLOGIES, INC., BEVERLY, MA (US)

(21) Appl. No.: 13/335,889

(22) Filed: Dec. 22, 2011

(51) Int. Cl. B08B 7/00; C23F 1/08

(52) U.S. Cl. 134/1.1; 156/345.38

(57) ABSTRACT

An apparatus configured to provide simultaneous plasma and electromagnetic irradiation of a workpiece within the same process chamber, thereby providing processes that permit simultaneous plasma and electromagnetic irradiation within the same atmosphere as may be desired for some applications.

### BACKGROUND

The present disclosure relates to plasma apparatuses and processes, and more particularly, to plasma generating apparatuses and processes adapted to provide simultaneous exposure of a workpiece to electromagnetic radiation and plasma or sequential exposure in any order within the same process chamber.

In the manufacture of integrated circuits, the technique of photolithography is required to form the integrated circuit patterns. In the practice of this technique, a semiconductor workpiece is coated with a photoresist. The photoresist is then selectively exposed to radiation that is passed through a mask so that a desired pattern is imaged on the photoresist. This causes changes in the solubility of the exposed areas of the photoresist such that after development in a suitable developer a desired pattern is fixed on the workpiece, whereupon the photoresist may be hardbaked or photostabilized to enable it to withstand subsequent processing.

After the integrated circuit components are formed, it is generally necessary to remove (i.e., ash) the photoresist from the workpiece as it has already served its useful purpose. The relative ease or difficulty with which the photoresist may be removed depends on the degree to which physical and chemical changes have been induced in the photoresist during plasma etching and/or ion implantation processes and on the degree to which cross-linking has occurred in the photoresist as a result of the prior processing. Thus, it is generally known that a significant degree of hard baking and, to an even greater extent, the processes of plasma etching and ion implantation induce physical and chemical changes in the photoresist, so that ashing is particularly difficult.

It is known to be advantageous to expose a post etched or post ion implanted photoresist layer to electromagnetic radiation such as ultraviolet (UV) radiation prior to plasma ashing to facilitate removal from the substrate by subsequent plasma processing. For example, it is believed that the UV radiation exposure causes photochemical rearrangements in the photoresist layer which, in turn, causes an increase in the removal efficiency during plasma ashing. As such, workpiece throughputs can be increased. Moreover, it has also been reported that as a direct result of UV radiation exposure, for example, the temperatures used during plasma mediated ashing can be increased without causing a corresponding increase in the well known blistering or popping phenomena within the photoresist. The increase in temperature during plasma mediated ashing desirably increases workpiece throughput.

Existing designs of plasma ashing equipment and ultraviolet irradiation tools are separate and distinct devices that employ separate chambers for exposure. As a result, the workpieces being processed are transferred from one device to another device or in the case of modular apparatuses, from one chamber to another chamber. In some instances, the workpieces are carried by an operator from one device to the other, and in other instances, a robotic transfer within the system occurs.

### BRIEF SUMMARY

Disclosed herein are plasma generating apparatuses and methods for simultaneously exposing or sequentially exposing, in any order, a workpiece to plasma and electromagnetic radiation in the same process chamber. In one embodiment, a plasma apparatus for removing photoresist, polymers and/or residues from a workpiece, the plasma apparatus comprises a plasma generating component for generating a plasma; an electromagnetic radiation source; and a process chamber for housing the workpiece in fluid communication with the plasma generating component comprising a top wall, a bottom wall and sidewalls extending therefrom, wherein at least one of the walls defining the process chamber comprises a material transparent to at least a portion of electromagnetic radiation emitted from the electromagnetic radiation source for isolating the electromagnetic radiation source from the process chamber while allowing electromagnetic radiation emitted from the electromagnetic radiation source to transmit into the process chamber; and wherein the plasma generating component and the electromagnetic radiation source are configured to simultaneously generate plasma and electromagnetic radiation in the process chamber or sequentially generate plasma and electromagnetic radiation in any order in the process chamber.

In another embodiment, the plasma apparatus comprises a gas source; an electromagnetic radiation source comprising a reflector and an electromagnetic radiation emitter; a vacuum process chamber adapted to process the one or more substrates simultaneously or in sequence, the process chamber having a top wall configured to define a sealed interior region with the reflector of the electromagnetic radiation source, a bottom wall and sidewalls extending therebetween, wherein the top wall is transparent to at least a portion of radiation emitted by the electromagnetic emitter and includes one or more openings in fluid communication with the gas source; an antenna array intermediate the one or more openings and a workpiece pedestal, wherein the antenna array comprises a plurality of conductor segments, each one of the conductor segments comprising an electrode and a dielectric material concentrically disposed about the electrode, wherein the dielectric material is hermetically sealed at each end against the sidewalls of the process chamber; and a power source in electrical communication with the electrode.

A process for removing photoresist, polymers and/or residues from a workpiece in a single process chamber, comprises exposing the workpiece to plasma and electromagnetic radiation in the single process chamber.

The above described and other features are exemplified by the following figures and detailed description.

### BRIEF DESCRIPTION OF THE DRAWINGS

Refer now to the figures, which are exemplary embodiments, and wherein like elements are numbered alike:

FIGS. 1 and 2 provide partial perspective exploded views illustrating a wide area plasma apparatus in accordance with an embodiment of the present disclosure;

FIG. 3 is a cross-sectional view of a plasma apparatus in accordance with an embodiment of the present disclosure; and

FIG. 4 shows a cross sectional view of an exemplary electromagnetic radiation source.

### DETAILED DESCRIPTION

Disclosed herein are plasma generating apparatuses and methods for simultaneously or sequentially, in any order, generating plasma and electromagnetic radiation and exposing the workpiece to the electromagnetic radiation and/or plasma in the same process chamber. As will be discussed in greater detail herein, the plasma generating apparatuses of the present disclosure generally include an electromagnetic radiation source, a plasma source, a single process chamber, and a wall (also referred to herein as a plate) disposed intermediate the electromagnetic radiation source and the single process chamber. The wall is made of a substance that is substantially transparent to the applied electromagnetic radiation of interest and does not degrade in the operating environment. The plasma generating source may be external to the process chamber such as in the case of a downstream plasma asher or may be internal to the process chamber such as in the case of a wide area radiofrequency plasma generator. For ease in understanding the present invention, reference herein will be made to an exemplary downstream microwave plasma generator that generates the plasma ex situ relative to the process chamber and an exemplary wide are RF plasma asher that generates the plasma in situ relative to the process chamber. However, it should be apparent that the invention is not intended to be limited to these particular plasma apparatuses and that the resulting apparatuses will be configured to provide simultaneous plasma and electromagnetic radiation exposure to a workpiece as may be desired for some applications or sequential exposure, in any order, to plasma and electromagnetic radiation in the same process chamber, i.e., without having to transfer the workpiece to be treated to a different process chamber.

In addition to being optically transparent to the desired electromagnetic radiation, the plate also serves to isolate the electromagnetic radiation source from the workpiece undergoing processing within the process chamber. In one embodiment, the plate is fabricated from a material such as fused silica, quartz, aluminum oxide, sapphire, magnesium difluoride, calcium fluoride, and the like, wherein the material has an optical transmittance substantially transparent to the desired electromagnetic radiation. An example of such a fused silica material is commercially available under the trade name Dynasil 1000 from the Dynasil Corporation in West Berlin, N.J.

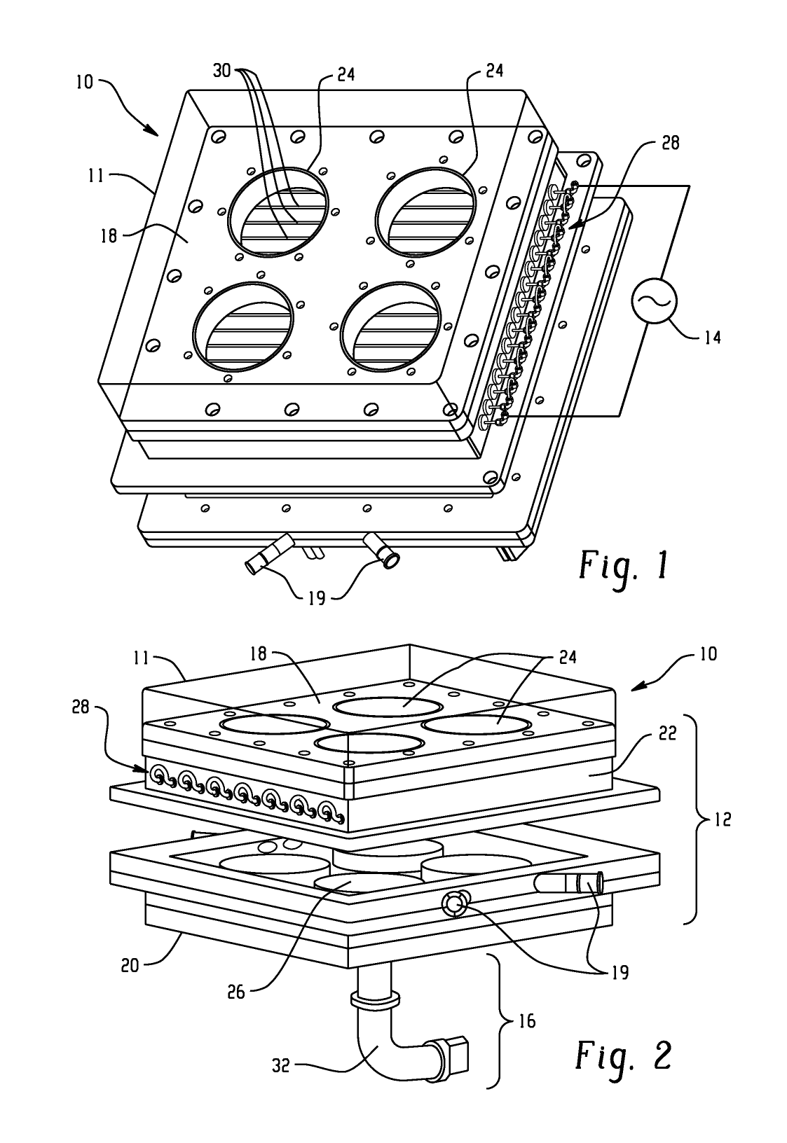

By way of illustration, an exemplary wide area radiofrequency (RF) plasma generator 10 for use in ashing or etching applications is depicted in FIGS. 1 and 2. In this particular plasma generator 10, multiple workpieces can be processed simultaneously. However, one of skill in the art would readily recognize that the apparatus can easily be configured to process a single workpiece such that simultaneous exposure to electromagnetic radiation and plasma can occur, if desired. The wide area RF plasma generator 10 generally comprises an electromagnetic radiation source 11, process chamber 12, a power source 14, and an exhaust assembly component 16. Although the apparatus 10 in FIGS. 1 and 2 has a square shape, other suitable shapes will be apparent to those skilled in the art in view of this disclosure and the desired plasma surface area. Exemplary wide area radiofrequency (RF) plasma generator that can be modified with the radiation source as described herein are described in U.S. Pat. No. 7,845,319, incorporated herein by reference in its entirety. The radiation source 11 is not limited to any particular shape and is generally configured to maximize reflectance and emission of electromagnetic radiation into the process chamber. Also, the terms “a”, “an”, and “the” do not denote a limitation of quantity, but rather denote the presence of at least one of the referenced item.

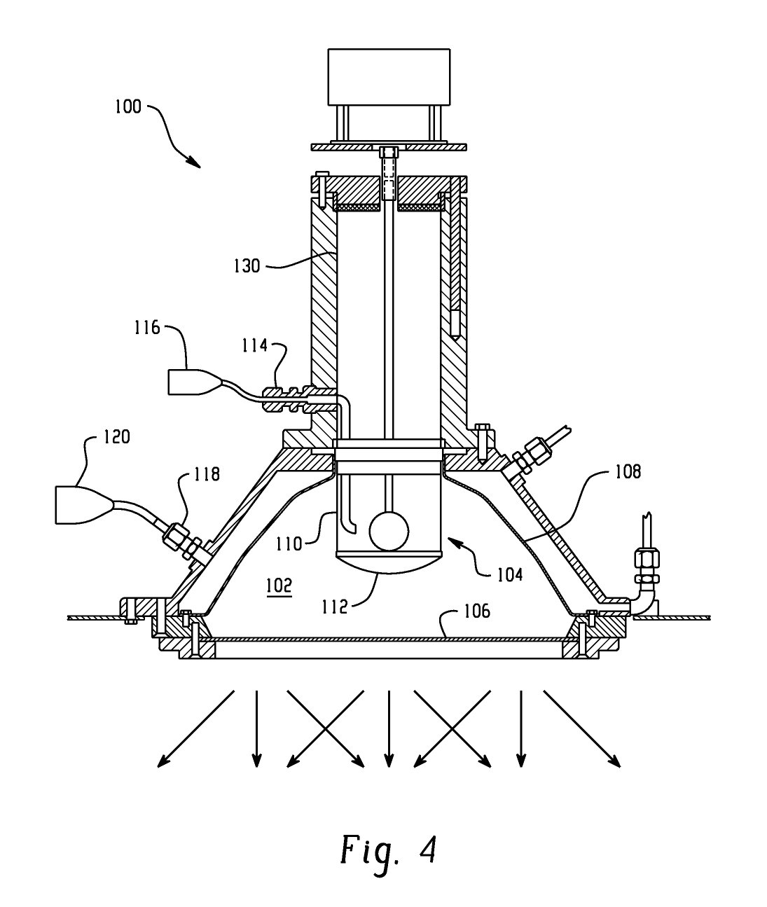

The process chamber 12 generally has a top plate 18, a bottom portion 20, and sidewalls 22 extending therebetween. The top plate 18 further comprises at least one gas input flanges (openings) 24, and in the present example there are four flanges. In this embodiment, the top plate 18 is substantially planar and is formed of an electromagnetic transparent material as was generally described above. It should be noted that although reference is made to the top plate being formed of the electromagnetically transparent material, other walls can be made electromagnetically transparent independently or in combination with the top plate. In one embodiment, at least one of the walls defining the process chamber is formed of the electromagnetically transparent material in its entirety. The radiation source 11 is optically coupled to the top plate 18 and will be described in greater detail below as it relates to FIG. 4.

The process chamber 12 further comprises a workpiece pedestal 26 within an interior of the process chamber. The workpiece pedestals 26 can function as a temperature control mechanism for the workpiece, whereby a heated platen provides heat to the workpiece, or a cooled platen removes heat from the workpiece. In one embodiment, the number of workpiece pedestals 26 generally corresponds to the number of gas flanges. Likewise, the diameter of the gas flanges is about the same as or greater than the diameter of a workpiece pedestal 26.

In the embodiment described above, each gas input flange 24 is positioned such that when the process chamber 12 is sealed, each flange 24 is coaxial to the corresponding workpiece pedestal 26. It should be clear to those practiced in the art that the number of gas input flanges need not be coaxial to the pedestal, and need not be equal to the number of pedestals in the chamber. A gas source (not shown) may be disposed in fluid communication with gas input flange 24. Suitable gases for generating plasma are well known to those skilled in the art of both etching and ashing, which include, but are not intended to be limited to, oxygen or oxygen containing gases, fluorine containing gases, hydrogen or hydrogen containing gases, ammonia, nitric oxide, nitrous oxide, carbon monoxide, carbon dioxide, helium, argon, neon, other inert gases, hydrocarbons, and combinations comprising one or more of the foregoing gases. The workpiece substrate pedestal 26 can be any suitable support generally known in the art such as, heated workpiece chucks, lift pins, and the like.

The process chamber 12 further includes an antenna system comprising a planar array 28 of antenna conductors 30 coupled together and in electrical communication with the power source 14 and with discrete electric components. Each conductor 30 is substantially parallel to an adjacent conductor. The antenna array 28 in the present example extends from one sidewall to an opposing sidewall to form a grating and is positioned intermediate the gas flanges 24 and the underlying workpiece pedestal 26. As will be discussed in greater detail below, the antenna array 28 provides excitation energy for plasma generation of gases flowing through the gas flanges 24 within the process chamber 12.

Additional openings 19 may also be disposed in the process chamber 12 for purposes generally known in the art such as, for example, a mass spectrometer inlet for analyzing gaseous species evolved during processing, endpoint detection, and the like. Moreover, the process chamber 12 may further include additional features depending on the application. Overhead RF sources, optical ports, gas analyzers, additional light sources, and the like could also be used either independently, or in combination, with the process chamber 12 providing an extremely flexible process platform. Other openings include one or more slit valves (not shown) disposed in the sidewall 22 for inserting and removing the substrates from the process chamber 12.

The process chamber 12 also includes an exhaust opening (not shown) disposed in the bottom wall 20 so as to provide an axial fluid flow in the chamber 12. An inlet of the exhaust conduit 32 is fluidly attached to the exhaust opening below each workpiece chuck in the process chamber 12. It is to be understood that the exhaust conduit 32 has been simplified to illustrate only those components that are relevant to an understanding of the present disclosure. Those of ordinary skill in the art will recognize that other components may be required to produce an operational plasma generating apparatus 10. However, because such components are well known in the art, and because they do not further aid in the understanding of the present disclosure, a discussion of such components is not provided.

Depending on the desired process (i.e., etching, ashing), operating pressures within the process chamber 12 are typically about 1 millitorr to about 3 torr, with about 200 millitorr to about 2 torr in other embodiments, and with about 500 millitorr to about 1.5 torr in still other embodiments. These operating pressures in the chamber are achieved using adequate process gas flows through the gas source and by using a throttle, or butterfly valve in fluid contact with the exhaust conduit 24 and exhaust opening. The power is typically in a range of less than about 100 watts up to a few thousand watts, at a frequency of about 0.5 megahertz (MHz) to 30 MHz. The temperature generally ranges from room temperature up to about 450° C. and may be constant or stepped during processing of the workpiece.

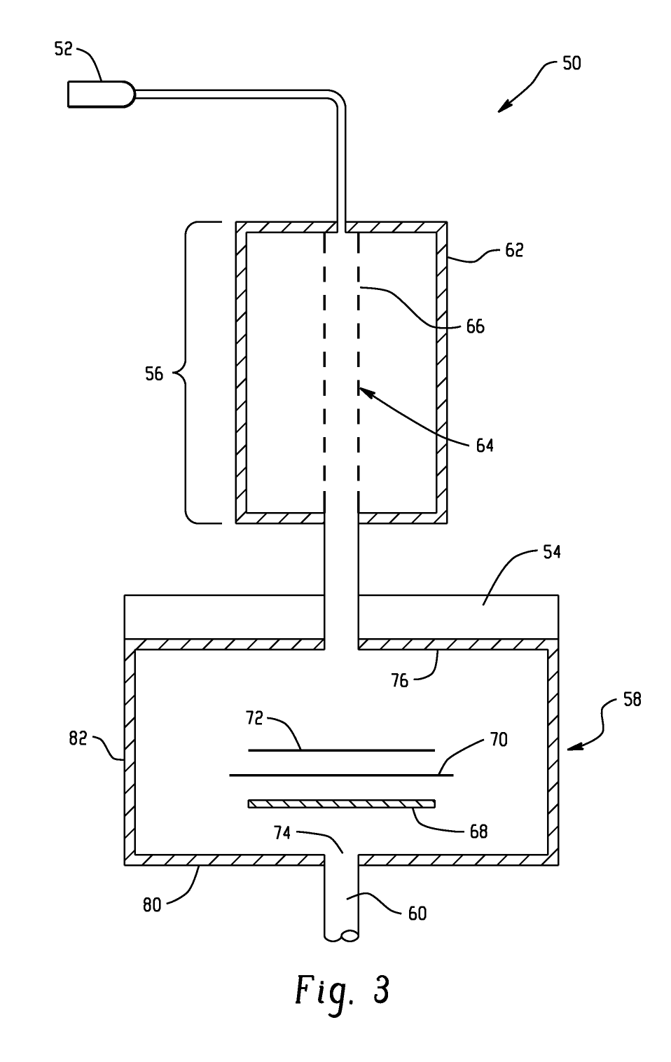

Referring now to FIG. 3, there is depicted an exemplary downstream plasma asher apparatus 50, wherein the plasma is generated upstream from a process chamber. As was the case for the wide area plasma apparatus of FIGS. 1 and 2, only those components relevant to understanding the present disclosure have been provided. Additional information on such operation as well as additional details regarding the various components may be found in U.S. Pat. Nos. 5,498,308 and 4,341,592, PCT International Application No. WO/97/37055, and U.S. patent application Ser. Nos. 10/249,964 and 13/117,488 to Axcelis Technologies, Inc., incorporated herein by reference in its entirety.

The plasma apparatus 50 generally includes a gas delivery component 52, a radiation source 54, a plasma generating component 56, a processing chamber 58, and an exhaust assembly 60. The gas delivery component 52 may include a gas purifier (not shown) in fluid communication with one or more gas sources of the gas delivery component that are in fluid communication with the plasma generating component. Using microwave excitation as an example of a suitable energy source for generating the plasma from a gas mixture, the plasma generating component 56 includes a microwave enclosure 62, which is generally a partitioned, rectangular box having the plasma tube 64 passing therethrough. As is known in the art, the microwave plasma generating component 56 is configured to cause excitation of the input gas into plasma so as to produce reactive species. In addition to microwave energy, the plasma generating component 56 could also be operated with an RF energy excitation source, a combination of RF and microwave energy, or the like. The plasma tube 64 includes a one or a plurality of gas inlet openings 66, one of which are shown, into which the gases from the gas delivery component 52 are fed.

Once the gases are excited, the reactive species produced in the plasma are introduced via the plasma tube 64 into an interior region of the processing chamber 58 for uniformly conveying the reactive species to the surface of a workpiece 68, such as a photoresist coated semiconductor wafer. In this regard, one or more baffle plates 70, 72 are typically included within the processing chamber 58. In order to further enhance the reaction rate of the photoresist and/or post etch residue with the reactive species produced by the upstream plasma, the workpiece 68 may be heated by an array of heating elements (e.g., tungsten halogen lamps, or a resistively heated chuck, not shown in the figures). An inlet 74 of the exhaust tube 60 is in fluid communication with an opening in the bottom plate for receiving exhaust gas into the exhaust tube 60.

The process chamber 58 includes a top wall 76 formed of an electromagnetic transparent material as described above, a bottom wall 80, and sidewalls 82 extending from the top wall to the bottom wall to define the interior region of the process chamber 56. The radiation source 54 is concentrically disposed about the plasma tube 64 and coupled to the top wall 76. Optionally, the top wall 76 as discussed above may be formed of a material that acts as a partial filter to the electromagnetic radiation to filter the workpiece from undesirable wavelengths of radiation. The material itself that defines the wall may serve as the filter or the top wall 76 may further include a coating.

The radiation sources 11 or 54 as described above can be readily modified for the particular plasma generating apparatus whether it be an ex situ plasma generator or an in situ plasma generator relative to the process chamber. For example, the radiation source can be concentrically disposed about the plasma tube for a downstream plasma apparatus. By way of example, an exemplary radiation source 100 is depicted in FIG. 4 and is generally configured for use with an in situ plasma generator. The exemplary radiation source generally comprises a sealed interior region 102 generally defined by an electromagnetic radiation transparent top wall 106 of a process chamber (e.g., 12 or 58), a reflector 108, and the electromagnetic radiation source 110, e.g., a UV bulb. A portion 110 of the electromagnetic radiation source 104 may protrude from and/or interfaces with the sealed interior region 102. In one embodiment, the source 104 is substantially transmissive to ultraviolet radiation and substantially opaque to microwaves, thereby acting as a high pass filter. For example, the terminal end 112 of portion 110 protruding from and/or interfacing with the sealed interior region 102 can be formed of an tungsten mesh material with sufficiently small openings to cut-off most microwave radiation while substantially transmitting the ultraviolet radiation.

The radiation source 104 further includes a fluid inlet 114 in fluid communication with the sealed interior region 103 and a fluid source 116. The fluid source 116 is configured to purge the atmosphere contained within the sealed interior region 102 during operation. In addition, the fluid source 116 can be used to cool the ultraviolet radiation source, e.g. the electrodeless bulb. Suitable fluids include, but are not intended to be limited to, inert gases for purging ambient air, for example, from the sealed interior region 102. Suitable inert gases include, but are not limited to, nitrogen, argon, helium, combinations comprising at least one of the foregoing gases, and the like. Similarly, the sealed interior region 102 can also be evacuated by means of a vacuum pump, exhaust, or the like (not shown) to allow optimum transmission of radiation. That is, oxygen or other species, for example, can be used to selectively absorb ultraviolet radiation at wavelengths less than 200 nm. As used herein the term, “sealed” as used in reference to the radiation source module (as well as the process chamber) refers to a region within the radiation source module that can be suitably purged during operation. The sealed interior region does not need to be vacuum-sealed and purging can simply provide a positive atmosphere within the interior region (or process chamber). Although in some embodiments, the sealed interior region can be vacuum-sealed depending on the application.

The radiation source 100 can also include fluid inlet 118 in fluid communication with a fluid source 120. In this manner, fluid such as water or some other cooling medium can be used to provide cooling to the reflector 108 or like components that may become heated during operation. For example, the reflector 108 may further include a water-cooling jacket wherein the fluid flows therethrough to provide the desired amount of cooling. The fluid selected for cooling can be the same or different from the fluid used for purging the sealed interior region 102. As such, fluid sources 116 or 120 are not intended to be limited to a single fluid and can provide multiple fluids as may be desired for different applications, wherein each fluid can be stored in a pressurized vessel or the like in fluid communication with inlet 114, 118, via a manifold or the like.

The reflector 108 includes a reflecting layer formed of an aluminum metal, a dichroic material, or a multilayer coating. Optionally, the reflecting layer may further comprise a protective layer of magnesium fluoride, silicon dioxide, aluminum oxide, and combinations comprising at least one of the foregoing materials. Other suitable materials will be apparent to one of ordinary skill in the art in view of this disclosure. These materials provide greater and more efficient reflectance of ultraviolet radiation having shorter wavelengths, e.g., wavelengths less than 200 nm.

The exemplary radiation source 100 can be adapted to emit a broadband radiation pattern having at least one broadband wavelength pattern less than about 400 nm, with about 150 nm to about 300 nm in other embodiments, and with about 150 nm to about 250 nm in still other embodiments.

The exemplary radiation source 100 as shown illustrates the use of an electrodeless bulb 130, which is coupled to an energy source, e.g., a microwave cavity, to emit the broadband radiation pattern in a manner well known by those skilled in the art to generate the desired broadband ultraviolet radiation pattern. Using a microwave energy source as an example, a magnetron and a waveguide are coupled to the microwave cavity to excite a gas fill within the electrodeless bulb and produce radiation. Different fills can be employed with the microwave electrodeless bulb to provide different radiation patterns. The amount of the fill is such that it can be present at a pressure of at least about 1 atmosphere and preferably 2 to 20 atmospheres at operating temperature when the fill is excited at a relatively high power density. For example, the power density of microwave energy would be at least 50 watts/cc, and preferably greater than 100 watts/cc. The electrodeless bulb can also be made to emit a desired broadband radiation pattern with radiofrequency power. Suitable microwave driven electrodeless bulbs are disclosed in U.S. Pat. No. 5,541,475 to Wood et al., incorporated herein by reference in its entirety.

The plasma reactor apparatuses advantageously allows for simultaneous exposure of a workpiece to plasma an electromagnetic radiation as may be desired in some application or sequential exposure of plasma and electromagnetic radiation, in any order, in the same process chamber.

Unless otherwise specified, the materials for fabricating the various components include metals, ceramics, glasses, quartz, polymers, composite materials, and combinations comprising at least one of the foregoing materials. For example, suitable metals include anodized aluminum, and/or stainless steel. Suitable ceramic materials include silicon carbide, or aluminum oxide (e.g., single crystal or polycrystalline).

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A plasma apparatus for removing photoresist, polymers and/or residues from a workpiece, the plasma apparatus comprising:
a plasma generating component for generating a plasma;
an electromagnetic radiation source; and
a process chamber for housing the workpiece in fluid communication with the plasma generating component comprising a top wall, a bottom wall and sidewalls extending therefrom, wherein at least one of the walls defining the process chamber comprises a material transparent to at least a portion of electromagnetic radiation emitted from the electromagnetic radiation source for isolating the electromagnetic radiation source from the process chamber while allowing electromagnetic radiation emitted from the electromagnetic radiation source to transmit into the process chamber; and wherein the plasma generating component and the electromagnetic radiation source are configured to simultaneously generate plasma and electromagnetic radiation in the process chamber or sequentially generate plasma and electromagnetic radiation in any order in the process chamber.

2. The plasma apparatus of claim 1, wherein the at least one of the walls defining the process chamber includes a window that is formed of a material transparent to at least a portion of electromagnetic radiation.

3. The plasma apparatus of claim 1, wherein the material defining the electromagnetic radiation transparent wall is formed of a fused silica, quartz, aluminum oxide, sapphire, magnesium fluoride, or calcium fluoride.

4. The plasma apparatus of claim 1, wherein the electromagnetic radiation is a portion of an ultraviolet radiation spectrum.

5. The plasma apparatus of claim 1, wherein the radiation source comprises a reflector and an electromagnetic emitting source in operative communication with the electromagnetic radiation transparent wall of the process chamber to define an interior region.

6. The plasma apparatus of claim 1, wherein the electromagnetic emitting source is an electrodeless bulb.

7. The plasma apparatus of claim 1, wherein the plasma generating component is external to an interior region of the process chamber such that the plasma is introduced into the process chamber.

8. The plasma apparatus of claim 7, wherein the plasma generating component comprises a downstream plasma apparatus.

9. The plasma apparatus of claim 8, wherein the downstream plasma apparatus comprises a plasma tube for introducing the plasma into the process chamber; and wherein the radiation source is concentrically disposed about the plasma tube and configured to emit electromagnetic radiation into the process chamber simultaneously or independently with the plasma.

10. The plasma apparatus of claim 7, wherein the downstream plasma apparatus is a microwave downstream plasma apparatus.

11. The plasma apparatus of claim 1, wherein the plasma generating component is internal to an interior region of the process chamber such that the plasma is generated within the interior region of the process chamber.

12. The plasma apparatus of claim 11, wherein the plasma generating is a dielectric discharge apparatus.

13. A plasma generating apparatus for removing photoresist, polymers and/or residues from a workpiece in a single process chamber, comprising:
a gas source;
an electromagnetic radiation source comprising a reflector and an electromagnetic radiation emitter;
a vacuum process chamber adapted to process the one or more substrates simultaneously or in sequence, the process chamber having a top wall configured to define a sealed interior region with the reflector of the electromagnetic radiation source, a bottom wall and sidewalls extending therebetween, wherein the top wall is transparent to at least a portion of radiation emitted by the electromagnetic emitter and includes one or more openings in fluid communication with the gas source;
an antenna array intermediate the one or more openings and a workpiece pedestal, wherein the antenna array comprises a plurality of conductor segments, each one of the conductor segments comprising an electrode and a dielectric material concentrically disposed about the electrode, wherein the dielectric material is hermetically sealed at each end against the sidewalls of the process chamber; and
a power source in electrical communication with the electrode.

14. The plasma generating apparatus of claim 13, wherein the top wall includes a window that is formed of a material transparent to at least a portion of electromagnetic radiation.

15. The plasma apparatus of claim 13, wherein the top wall of the process chamber is formed of a material comprising a fused silica, quartz, aluminum oxide, sapphire, magnesium fluoride, or calcium fluoride.

16. The plasma apparatus of claim 13, wherein the electromagnetic radiation emitter is an electrodeless bulb configured to emit radiation within at least a portion of an ultraviolet radiation spectrum.

17. The plasma apparatus of claim 13, wherein the top wall is planar.

18. The plasma apparatus of claim 13, wherein the power source is a radio frequency power supply.

19. A process for removing photoresist, polymers and/or residues from a workpiece in a single process chamber, comprising:
exposing the workpiece to plasma and electromagnetic radiation in the single process chamber.

20. The process of claim 19, wherein exposing the workpiece to plasma and electromagnetic radiation in the single process chamber comprises simultaneously exposing the workpiece to plasma and electromagnetic radiation in the single process chamber.

21. The process of claim 19, wherein exposing the workpiece to plasma and electromagnetic radiation in the single process chamber comprises sequentially exposing the workpiece, in any order, to the plasma and the electromagnetic radiation in the single process chamber.
